(19) United States
(12) Patent Application Publication
(10) Pub. No.: US 2017/0004344 A1
(43) Pub. Date: Jan. 5, 2017

(54) Robust Eye Tracking for Scanning Laser Ophthalmoscope

(71) Applicants: CANON KABUSHIKI KAISHA, Tokyo (JP); UNIVERSITY OF ROCHESTER, Rochester, NY (US)

(72) Inventors: Koji Nozato, Rochester, NY (US); Kenichi Saito, Yokohama-shi (JP); Qiang Yang, Rochester, NY (US); Jie Zhang, Pittsford, NY (US)

(21) Appl. No.: 14/791,088

(22) Filed: Jul. 2, 2015

(51) Int. Cl. G06K 9/00; G06K 9/52; G06T 7/20; H04N 5/232; G06T 7/00; G06K 9/46

(52) U.S. Cl. CPC G06K 9/0061; G06K 9/00604; G06T 7/0014; G06K 9/46; G06T 7/20; G06T 7/0044; H04N 5/23222; G06K 9/00617; G06K 9/52; G06K 2009/4666; G06T 2207/30041

(57) ABSTRACT

A system, apparatus, and method of obtaining an image of a fundus. Acquiring a reference image of the fundus at a first point in time. Acquiring a target image of the fundus at a second point in time. The target imaging area may overlap with the reference imaging area. An area of the target imaging area may be less than an area of the reference imaging area. Estimating movement of the fundus may be based upon at least the target image and the reference image. Acquiring a narrow field image of the fundus. An area of the narrow field imaging area may be less than the area of the target imaging area. A position of the narrow imaging area on the fundus may be adjusted based on the estimated movement of the fundus.

### GOVERNMENT LICENSE RIGHTS

This invention was made with government support under grant numbers EY014375 and EY001319 awarded by the National Institutes of Health. The Government has certain rights in the invention.

### BACKGROUND

Field of Art

The present disclosure relates to a system and method for eye tracking in an ophthalmoscope.

Description of the Related Art

In recent years, scanning light ophthalmoscopes (SLOs) that irradiate the fundus with laser light in two dimensions and receive reflected light therefrom and an imaging apparatuses that utilizes the interference of low coherence light have been developed as ophthalmic image pickup apparatuses. Thus, SLOs have become important tools for the study of the human retina in both normal and diseased eyes.

The resolution of such SLOs have been improved by, for example, achieving high NA of irradiation laser light. However, eye movement is still a big issue for imaging the eye with an SLO. A typical SLO will take multiple source images and average them to create a final image with a higher signal to noise (S/N) ratio. The typical SLO will also take multiple source images so that a final panoramic image of the eye may be constructed that has a wider field of view (FOV) than the source images. In order to construct these final images, each frame should be at an exact position. This can be very difficult because the eye moves continuously during imaging. In particular, with a small FOV system such as an Adaptive Optics SLO (AO-SLO), the eye movement is quite large relative to the frame size and the imaging area can easily go out of frame due to the eye movement.

In order to address this problem, an eye position tracking system has been developed. It detects eye position by a position detection apparatus and shifts the imaging area according to the eye movement by the use of tracking mirrors or other methods. An Image base position calculation method or the detection of specific feature methods are used as the position detection apparatus.

One problem with eye position tracking systems that use image-based eye tracking for scanning laser ophthalmoscopy is that they are vulnerable to the issue of ‘frame out’ due to eye drift, where the tracking system stops working or makes incorrect decisions when the eye drifts out of mapping range of the reference image.

### SUMMARY

A system, apparatus, and method of obtaining an image of a fundus. Which may include acquiring a reference image representing light reflected from a reference imaging area of the fundus at a first point in time. Which may include acquiring a target image representing light reflected from a target imaging area of the fundus at a second point in time after the first point in time. All or a portion of the target imaging area may overlap with the reference imaging area. Estimating movement of the fundus between the first point in time and the second point in time may be based upon at least the target image and the reference image. Which may include, acquiring a narrow field image representing light reflected from a narrow field imaging area of the fundus. An area of the narrow field imaging area may be less than an area of the target imaging area. A position of the narrow imaging area on the fundus may be adjusted based on the estimated movement of the fundus.

A pixel density of the target image may be equal to a pixel density of the reference image.

An embodiment may include determining if the target image or the estimated movement of the target imaging area may be abnormal. In a first case that the target image or the estimated movement of the target imaging area may be abnormal, an embodiment may include reacquiring the target image before obtaining the narrow field image. In a second case that the target image or the detected movement of the target imaging area may not be abnormal, an embodiment may include reacquiring the target image representing light reflected from the target imaging area taking the detected movement into account. In an alternative embodiment, in the first case also reacquiring the reference image before obtaining the narrow field image.

In an embodiment, one or more conditions may be used to determine if the target image maybe abnormal or the estimated movement is abnormal. The conditions may include the estimated movement is greater than a movement threshold. The conditions may include a confidence value which represents a probability that the estimated movement is correct is greater than a confidence threshold. The conditions may include an overlap percentage that represents a portion of the target image that overlaps with the reference image may be less than an overlap threshold. The conditions may include a blink has been detected.

In an embodiment, the reference image may be obtained with a first imaging system. In an embodiment, the target image may be obtained with the first imaging system. In an embodiment, the narrow field image may be obtained with a second imaging system. In an embodiment, the first imaging system and the second imaging system may share some optical components.

In an embodiment, the first imaging system may be a scanning laser ophthalmoscope. In an embodiment, the second imaging system may be an adaptive optics scanning laser ophthalmoscope.

In an embodiment, the reference image and the target image may be obtained with a scanning laser ophthalmoscope that may include a first scanner. In an embodiment, a first signal may be used to drive the first scanner, such that the reference image is obtained. In an embodiment, a second signal may be used to drive the first scanner, such that the target image is obtained. In an embodiment, a first ramp rate of the first signal may be substantially equal to a second ramp rate of the second signal.

In an embodiment, the scanning laser ophthalmoscope may further comprise a second scanner. The second scanner may scan in the first direction at a second scanning rate forming lines of the reference image and the target image. The first scanner may scan in the second direction at a first scanning rate faster than the second scanning rate forming the reference image and the target image.

In an embodiment, a reference image pixel density of the reference image may be substantially equal to a target image pixel density of the target image.

In an embodiment, a reference image line density of the reference image may be substantially equal to a target image line density of the target image.

In an embodiment, the movement of the fundus may be estimated by using one or more of the techniques selected from the group consisting of: one or more cross-correlation techniques; one or more Fourier transform techniques; one or more sequential similarity detection techniques; one or more phase correlation techniques; and one or more landmark mapping techniques.

An embodiment may be a non-transitory computer readable medium encoded with instructions for performing the method of one or more of the other embodiments.

An embodiment may include, readjusting a position of the target imaging area at a first rate, based on the previous estimated movement. An embodiment may include, reacquiring the target image at the adjusted position at the first rate. An embodiment may include, re-estimating the movement of the fundus based upon at least a most recently obtained target image and the reference image. An embodiment may include, reacquiring the narrow field image, at a position that has been re-adjusted based on the most recent estimation of the movement of the fundus. An embodiment may include, a period of time between the reacquiring of subsequent target images at the first rate may be less than a period of time that may be used to obtain the reference image.

In an embodiment adjusting and readjusting the target imaging area may be done by adding one or more target image offsets to one or more target image signals which may be sent to one or more target image scanning mirrors that may be used to scan the target imaging area. The one or more target image offsets may be based on the most recently obtained estimated motion of the fundus. Adjusting and readjusting the narrow field imaging area may be done by adding one or more narrow field offsets to one or more narrow field signals which may be sent to one or more narrow field scanning mirrors that may be used to scan the narrow field imaging area. Wherein the one or more narrow field offsets may be based on the most recently obtained estimated motion of the fundus.

In an embodiment, the target imaging offsets are such that a position of the target imaging area may be adjusted along a first axis and may not be adjusted along a second axis orthogonal to the first axis.

An embodiment may include, adjusting and readjusting the target imaging area and the narrow field imaging area may be done by adding one or more offsets to one or more signals which may be sent to one or more mirrors that may be used to position both the target imaging area and the narrow field imaging area. The one or more offsets may be based on the most recently obtained estimated motion of the fundus.

In an embodiment, the narrow field image and the target image may be both reacquired concurrently.

In an embodiment, the estimation of the movement of the fundus may also be based upon one or more narrow field images.

In an embodiment, the position of the narrow imaging area on the fundus may be adjusted and readjusted such that narrow field image does not overlap with the target image.

In an embodiment, the light reflected from the reference imaging area of the fundus, the light reflected from the target imaging area of the fundus, and the light reflected from the narrow field imaging area of the fundus are one of non-visible light or infrared light.

In an embodiment, the light reflected light reflected from the reference imaging area of the fundus, and the light reflected from the target imaging area of the fundus, have a first wavelength spectrum. The light reflected from the narrow field imaging area has a second wavelength spectrum different from the first wavelength spectrum.

In an embodiment, adjusting an imaging size of the target field imaging area may be based on one or more of: an amount of the estimated movement of the fundus; a signal strength of the reference image and the target image; and a contrast ratio of the reference image and the target image.

An embodiment may be an apparatus for obtaining an image of a fundus. The apparatus may include one or more processors. The apparatus may include a first imaging system for obtaining an image of the fundus. The apparatus may include a second imaging system for obtaining an image of the fundus. The first imaging system and the second imaging system may share one or more optical components. An embodiment may include, acquiring a reference image which may represent light reflected from a reference imaging area of the fundus with the first imaging system at a first point in time. An embodiment may include, acquiring a target image representing light reflected from a target imaging area of the fundus first imaging system at a second point in time after the first point in time. All or a portion of the target imaging area may overlap with the reference imaging area. An area of the target imaging area may be less than an area of the reference imaging area. The one or more processors may estimate movement of the fundus between the first point in time and the second point based upon at least the target image and the reference image. An embodiment may include, acquiring a narrow field image may represent light reflected from a narrow field imaging area of the fundus with the second imaging system. An area of the narrow field imaging area may be less than the area of the target imaging area. A position of the narrow field image on the fundus may be adjusted based on the estimated movement.

### BRIEF DESCRIPTION OF THE DRAWINGS

The accompanying drawings, which are incorporated in and constitute a part of the specification, illustrate exemplary embodiments.

FIGS. 1A-G are illustrations of an ophthalmoscope in which an embodiment may be implemented;

FIG. 2 is an illustration of a tracking system which may be used in an embodiment.

FIG. 3 is an illustration of a tracking system which may be used in an embodiment.

FIGS. 4A-C are illustrations of exemplary images that may be obtained in an embodiment.

FIG. 5 is an illustration of a tracking method which may be used in an embodiment.

FIG. 6 is an illustration of a driving signal for a slow scanner as might be used in an embodiment.

FIGS. 7A-B are illustrations of imaging areas and their relative positions to each other as they might be used in an embodiment.

FIGS. 8A-C are illustrations of exemplary methods that may be used in an embodiment.

FIG. 9 is an illustration of a controller that may be used in an embodiment.

### DESCRIPTION OF THE EMBODIMENTS

Embodiments will be described below with reference to the attached drawings. Like numbers refer to like elements throughout. Exemplary embodiments will be described in detail with reference to the drawings below. It shall be noted that the following description is merely illustrative and exemplary in nature, and is in no way intended to limit the disclosure and its applications or uses. The relative arrangement of components and steps, numerical expressions and numerical values set forth in the embodiments do not limit the scope of the disclosure unless it is otherwise specifically stated. Techniques, methods, and devices which are well known by individuals skilled in the art may not have been discussed in detail since an individual skilled in the art would not need to know these details to enable the embodiments discussed below. Further, an image photographing apparatus as disclosed in the following can be applied to an object to be inspected such as an eye to be inspected, skin, and internal organs.

### Ophthalmoscope

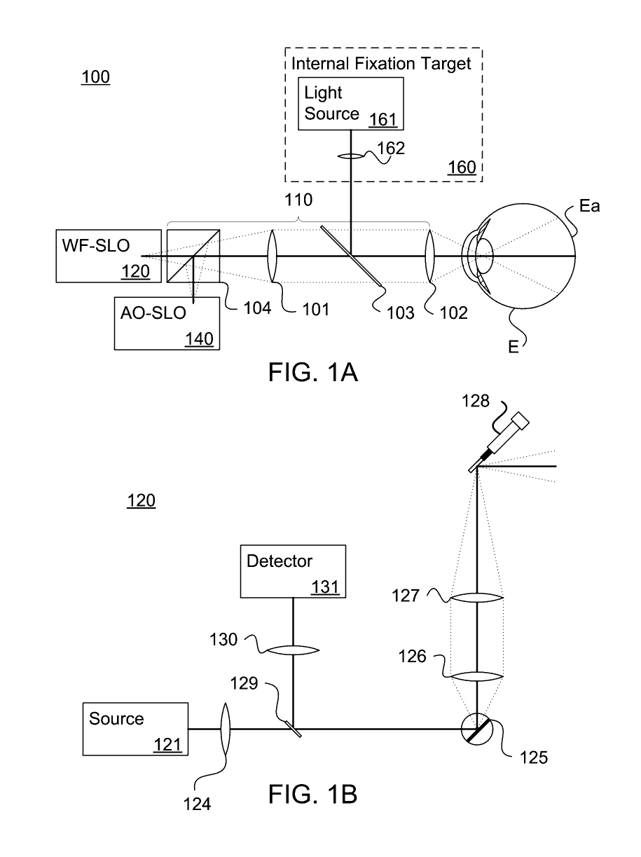

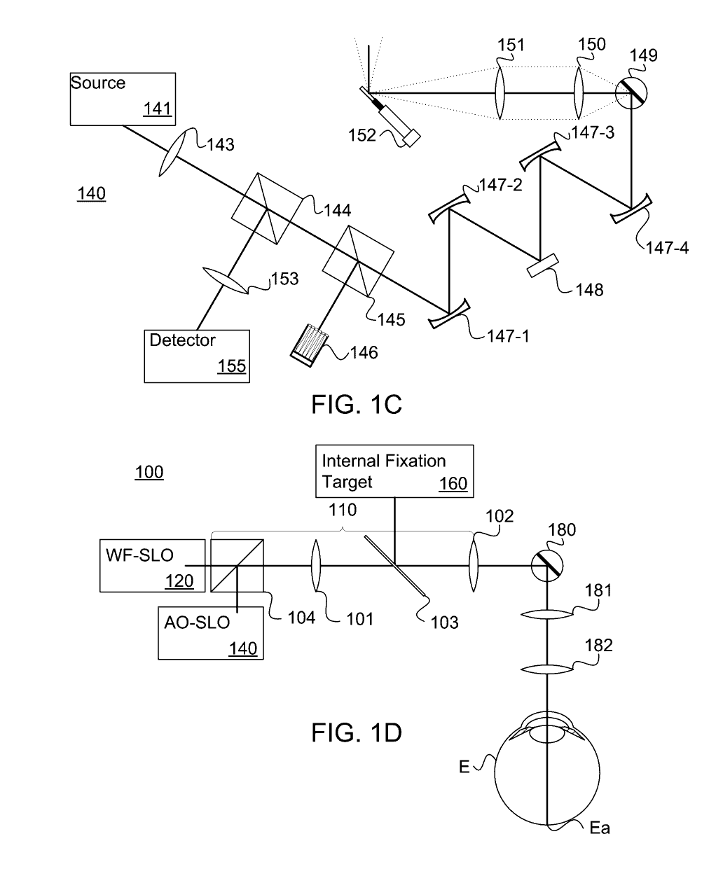

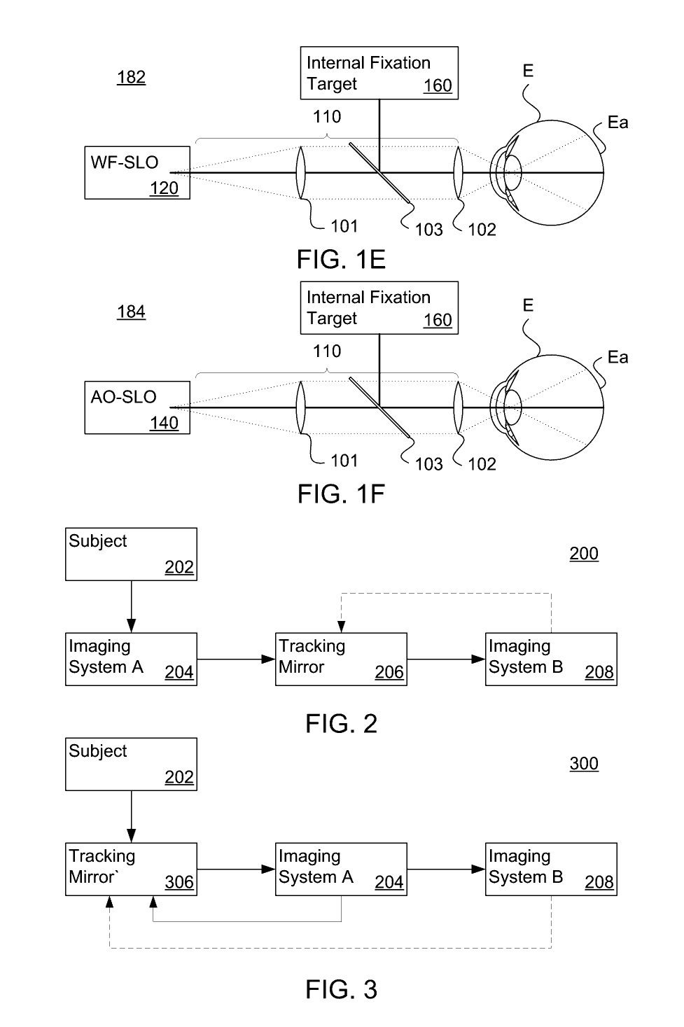

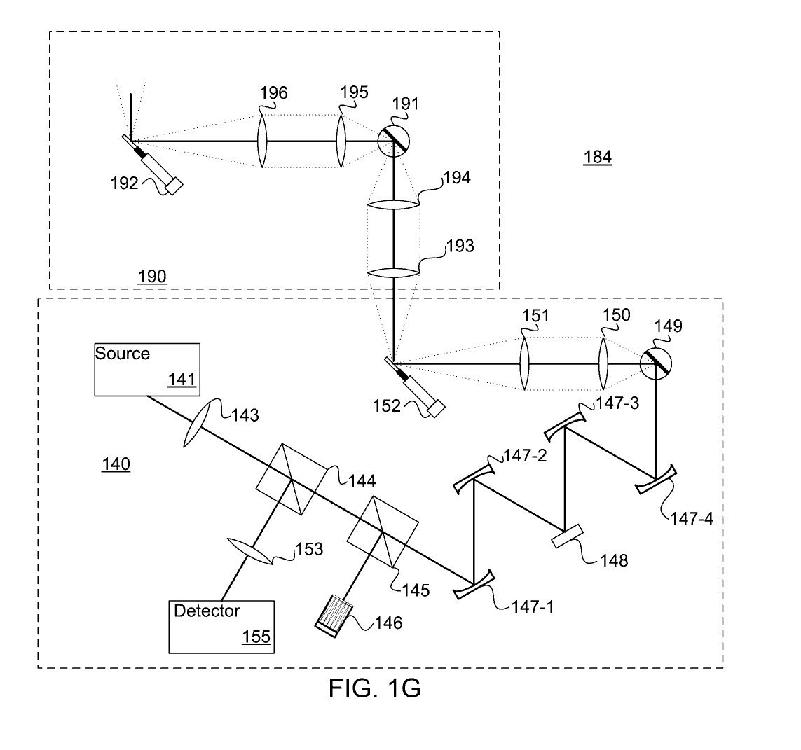

An embodiment will be described in the context of an ophthalmoscope 100 that is illustrated in FIGS. 1A-C. The ophthalmoscope may be also referred to as the system 100 in the context of this application. The ophthalmoscope 100 includes an ocular lens unit 110, a wide field scanning laser ophthalmoscope (WF-SLO) 120, an adaptive optics scanning laser ophthalmoscope (AO-SLO) 140, and an internal fixation target 160. A scanning beam of the WF-SLO 120 and a scanning beam of the AO-SLO 140 enter a fundus of a subject E. In one embodiment, the beams enter the fundus simultaneously, and each of the beams have different wavelengths. In another embodiment, the beams enter the fundus at separate times. This may be done using pulsed light sources, optical switches, a single light source and a dual output Mach-Zehnder modulator, or a variety of other methods in which light can be combined and then independently detected may be used.

The ocular lens unit 110 may include a first beam combiner 104 for combining the beams to and from the WF-SLO 120 and the beams to and from the AO-SLO 140 to form a combined beam. The first beam combiner 104 may include a partially silvered mirror in which case, the beams may have similar wavelengths. The first beam combiner 104 may include a dichroic mirror in which case, wavelength ranges of the beams to and from the WF-SLO 120 may be different from wavelength ranges of the beams to and from the AO-SLO 140. The first beam combiner 104 may be a switch in which case the switch may be used to temporally multiplex beams to and from the WF-SLO 120 and the beams to and from the AO-SLO 140.

The ocular lens unit 110 may also include a first lens 101 and a second lens 102 which are used to transmit the combined light from the beam combiner 104 to an object E. The first lens 101 and the second lens 102 may be replaced with curved mirrors. A dichroic filter 103 may be inserted between the first lens 101 and the second lens 102 in order to combine the combined light from the beam combiner 104 with light from an internal fixation target 160. In an alternative embodiment, the dichroic filter 103 may be inserted between the second lens 102 and the object E. The internal fixation target 160 may include a first light source 161 and a third lens 162. The first light source 161 may be multiple light emitting diodes arranged in matrix. A turn-on position of the light emitting diodes in the first light source 161 may be changed by a controller in accordance with the part of the E desired to be imaged. Light from the first light source 161 is guided to the eye E to be inspected by the dichroic filter 103 via the third lens 162. The light emitted from the first light source 161 is visible light and may have a wavelength of 520 nm.

An example of the WF-SLO 120 is illustrated in FIG. 1B. The WF-SLO 120 includes a second light source 121 or an input for receiving light from the second light source 121. The second light source 121 may be a laser, a lamp, a diode, a semiconductor laser, a super luminescent diode, a gas laser, a fiber coupled light source, a fiber based light source, some other suitable light source, or a set of light sources. The second light source 121 may be coherent or incoherent. In order to reduce the brightness as perceived by the subject while maintaining suitable resolution for fundus observation, a wavelength of the second light source 121 may be in the near infrared range of 700 nm to 1,000 nm. The wavelength of the second light source 121 may be non-visible light. In an embodiment, a semiconductor laser having a wavelength of 780 nm is used. Light emitted from the second light source 121 may be transmitted through a fiber to be emitted from a fiber collimator as a collimated beam (measuring light).

The measuring light passes through a first beam splitter 129 and a fourth lens 124 and is guided to a first scanner 125. The first scanner 125 may be a resonant scanner which scans the light along a first axis. The measuring light from the first scanner 125 may then pass through a fifth lens 126 and a sixth lens 127 which may focus the light onto a second scanner 128. The second scanner 128 may be a galvano scanner driven by a triangle signal or a saw tooth signal both of which are ramp signals along a second axis. Light from the second scanner is then transmitted via the ocular lens unit 110 to the subject E. The ocular lens unit 110 gathers light from the subject E and guides back into the WF-SLO 120. The gathered light from the subject E that has been guided back to WF-SLO 120 by the combiner 104 is then sent back through the second scanner 128, the fifth lens 126 and the sixth lens 127, and the first scanner 125 before it hits the first beam splitter 129. The first beam splitter 129 guides a portion of the gathered light to a seventh lens 130 and to a first detector 131.

The first axis and the second axis are substantially orthogonal to each other. The first axis corresponds to a main scanning direction, and the second axis corresponds to a sub scanning direction.

The beam that has entered the eye E irradiates a fundus Ea of the eye to inspect the subject E as a beam spot. This beam is reflected or scattered by the fundus Ea of the eye E to be inspected and follows the same optical path and is received by the first detector 131 which may be an avalanche photodiode (APD).

In an alternative embodiment, the second source 121 is a fiber coupled light source, the seventh lens 130 is GRIN lens that couples the fiber coupled light to the first detector 131, the first beam splitter 129 is a fused fiber coupler or a fiber coupled beam splitter, and the fourth lens 124 is a fiber coupled GRIN lens.

FIG. 1C is an illustration of an exemplary AO-SLO 140 which may be used in an embodiment. The AO-SLO 140 may use a third light source 141. The third light source 141 may be a SLD light source having a wavelength of 840 nm. The third light source 141 may be a non-visible light source or an infrared light source. The third light source 141 may have wavelength spectrum that is different from a wavelength spectrum of the second light source 121. The third light source 141 may be shared for imaging the fundus Ea and for measuring a wavefront of the image. In an alternative embodiment, the wavefront may be measured with one wavelength while the fundus is imaged with a second different wavelength.

The light emitted from the third light source 141 may be transmitted through a fiber to be radiated via an eighth lens 143 or a fiber collimator as collimated measuring light. The embodiment may include the third light source 141 or include an input for the third light source 141. The radiated measuring light is transmitted through a second beam splitter 144 and guided to a compensation optical system.

The compensation optical system includes a third beam splitter 145, a wavefront sensor 146 for measuring aberration, a wavefront correction device 148, and mirrors 147-1 to 147-4 (first mirror 147-1; second mirror 147-2; third mirror 147-3; and fourth mirror 147-4) for guiding the light to those components. The mirrors 147-1 to 147-4 may be arranged such that the eye E to be inspected, the wavefront sensor 146, and the wavefront correction device 148 may have an optically conjugate relationship to each other. The wavefront correction device 148 may be a spatial phase modulator, such as a reflective liquid crystal element, a deformable mirror, or a translucent liquid crystal element.

The measuring light may enter the wavefront correction device 148 and may be emitted to the third mirror 147-3. Similarly, the light that has returned from the fundus Ea of the eye E, enters the wavefront correction device 148, and is then emitted to the second mirror 147-2. The measuring light is scanned two-dimensionally by a third scanner 149 which is then sent to a fourth scanner 152 via ninth lens 150 and a tenth lens 151. The third scanner 149 may be a high-speed resonance scanner. The fourth scanner 152 may be a galvano scanner. The third scanner 149 and the fourth scanner 152 scan in directions that are in substantially orthogonal directions to each other. The third scanner 149 may scan along the first axis in the same manner as the first scanner 125. The third scanner 149 may scan along the x-axis. The fourth scanner 152 may scan along the y-axis.

The measuring light scanned by the third scanner 149 and the fourth scanner 152 is then transmitted via the ocular lens unit 110 to the subject E. The ocular lens unit 110 gathers light from the subject E and guides it back into the AO-SLO 140. The gathered light from the subject E that has been guided back to AO-SLO 140 by the combiner 104 is then sent back through the fourth scanner 152, the ninth lens 150 and the tenth lens 151, the third scanner 149, mirror 147-4, mirror 147-3, wavefront correction device 148, mirror 147-2, and mirror 147-1, before it hits the third beam splitter 145. The third beam splitter 145 guides a portion of the gathered light to the wavefront sensor 146. The third beam splitter 145 guides another portion of the gathered light to a second beam splitter 144. The second beam splitter 144 guides the gathered light to an eleventh lens 153 and to a second detector 155.

The measuring light that has entered the eye E to be inspected has been reflected or scattered by the fundus Ea and follows the same optical path as the measurement light. The wavefront sensor 146 measures a wavefront of the beam from the fundus Ea. The wavefront sensor 146 may be a Shack-Hartmann sensor, a pyramid wavefront sensor, or some other method for characterizing a wavefront. The detector 155 may be a photomultiplier tube. The detector 155 may be a fiber coupled detector and the lens 153 may be a fiber collimator. In an alternative embodiment, the second beam splitter 144 is a partially silvered prism.

In an alternative embodiment, the third source 141 is a fiber coupled light source or is coupled to a fiber via the eighth lens 143, the eleventh lens 153 is a GRIN lens that couples the fiber coupled light to the second detector 155, the second beam splitter 144 is a fused fiber coupler or a fiber coupled beam splitter, and is collimated by a fiber coupled GRIN lens.

The first detector 131 converts light into an electrical signal which is then converted into a wide field image of a portion the fundus Ea. The second detector 155 converts light into an electrical signal which is then converted into a narrow field image of a narrower portion of the fundus Ea.

The wavefront sensor 146 and the wavefront correction device 148 are connected to each other. One or more processors may be used to calculate a modulation amount of the wavefront correction device 148 which is calculated based on information from the wavefront sensor 146. The wavefront sensor 146 and the wavefront correction device 148 may form a closed loop feedback system.

FIG. 1D is an illustration of an embodiment that also includes a tracking mirror 180, a first relay lens 181 and a second relay lens 182. The tracking mirror 180 may consist of 2 scanners or one 2-dimensional scanner. The tracking mirror 180 is moved to compensate for detected movements of the subject E, such that the fundus Ea stays in focus and within the field of view. In an alternative embodiment, there is no tracking mirror and the scanning mirrors 125, 128, 149, and 152 are moved to compensate for the detected movements of the subject E, such that the fundus Ea stays in focus and within the field of view. In other embodiments, there may be additional tracking mirrors to compensate for the detected movements of the subject E in addition to the scanning mirrors 125, 128, 149, and 152.

FIG. 1E is an illustration of an embodiment 182 that includes the WF-SLO 120 but does not include the AO-SLO 140. The embodiment 182 does not include the first beam combiner 104 but it might include the tracking mirror 180.

FIG. 1F is an illustration of an embodiment 184 that includes the AO-SLO 140 but does not include the WF-SLO 140. The embodiment 184 does not include the first beam combiner 104 but it might include the tracking mirror 180. FIG. 1G is an illustration of an embodiment 184 that includes the AO-SLO 140 that may not include the WF-SLO 140. The embodiment 184 may include a tracking system 190 that includes 2 tracking mirrors 191 and 192 and relay lenses 193-198. The two tracking mirrors 191 and 192 may be replaced with a single tip/tilt mirror. An alternative embodiment may include the overall system illustrated in FIG. 1D in which the AO-SLO 140 is replaced with an AO-SLO 184 illustrated in FIG. 1G. An alternative embodiment may include one or more steering mirrors which are used to move imaging positions of imaging areas obtained by either, the WF-SLO, the AO-SLO, or both.

An alternative embodiment, may include two different tip-tilt mirrors or two sets of single axis mirrors may be used in concert for optical stabilization. A coarse tip-tilt mirror may be used for coarse optical stabilization. A fine tip-tilt mirror may be used for fine optical stabilization. One or both of the tip-tilt mirrors may be replaced with two single axis rotating mirrors.

In an alternative embodiment, the WF-SLO 120 may use second light source 121 with an imaging wavelength of 920 nm. The field of view (FOV) of the WF-SLO 120 may be approximately 27°×23°. During stabilization, the FOV of the WF-SLO 120 may be approximately 27°×6.5°. The frame rate for the WF-SLO 120 for full FOV may be 15 frames per second (fps). During stabilization, the frame rate for the WF-SLO 120 may be approximately 51 fps. The stabilization range for the WF-SLO 120 may be ±3°. The prescription range for the WF-SLO 120 may be −10.5 Diopters (D) to +5.5 D.

In an alternative embodiment, the AL-SLO 140 may use second light source 141 with imaging broadband fluorescence excitation wavelength is 532 nm, the reflectance imaging wave wavelength may be 680 nm and/or 790 nm. The wavefront sensor 146 may be a Shack-Hartmann sensor with a measurement wavelength of 847 nm. The wavefront correction device 148 may be a deformable mirror such as DM97-15 by ALPAO (Montbonnot, France). Alternatively, the wavefront correction device may be a transmittance type spatial phase modulator. The FOV of the AO-SLO 140 may be approximately 1.5°×1.5°. The range of the FOV of the AO-SLO 140 may be 0.5°-2°. The frame rate for the AO-SLO 140 may be 21 frames per second (fps). The stabilization range for the AO-SLO 120 may be ±2.6°. The prescription range for the WF-SLO 120 may be −5.5 D to +1.5 D.

In an alternative embodiment, the AL-SLO 140 and/or the WF-SLO 120 may include one or more steering systems with a range of about ±7.5° around a single fixation target. The total steering range may be about ±17.8°.

### Eye Tracking System

When the subject being imaged is a moving live object, than it is helpful to have a tracking system which compensates for the movements of the subject. This allows for the multiple image frames to be averaged and or stitched together. A series of images may also be obtained to create a video of the object in which the overall motion of the object being imaged is removed from the images, but the changes within the image are apparent. For example, a video image of pulsating blood vessels (veins and arteries) may be obtained, while the motion of the eye is substantially removed but the motion of the blood is visible. In one embodiment, image frames are captured at a fast rate relative to the motion of the object. In which case, the tracking mirror 180 is moved in between frames. In another embodiment, image frames are captured at a slower rate relative to the motion of the object. In which case, the tracking mirror 180 may be moved while the image frame is being captured. An embodiment, may include a separate beam steering system. The beam steering system may be used to steer either, the WF-SLO, the AO-SLO, or both. The beam steering system may be used to image a series of small images which are then stitched together to form a large high resolution image.

An image based tracking system 200 is illustrated in FIG. 2 for tracking the motion of an object responding to the motion. The tracking system 200 may be a real time tracking system. The subject being tracked by the tracking system 200 may be used for tracking a subject 202 such as an eye. The tracking system may include obtaining a reference image of the subject 202. This reference image may be chosen manually by an operator. The reference image may be obtained automatically by the tracking system 200.

Target images such as those in a video sequence of images may be registered relative to the reference image. The target image may registered by using a cross correlation method, a method based on feature detection, or some other method in which the target either whole or in part is compared to the reference image. The cross-correlation method may be an FFT based cross-correlation method eye motion, whether smooth eye movements, or saccadic eye movements from these target images are fed back to a tracking mirror 206. The tracking mirror 206 may dynamically follow the subject 202 (eye) location and/or motion. This feedback process may be a type of optical tracking. Thus, the relative motion of the subject 206 after optical tracking is taken into account may be significantly reduced. Any remaining image motions may be referred to as residual image motions.

FIG. 2 is a diagram of an image based eye tracking system 200 with open-loop control where image motions from imaging system A 204 are used to control the tracking mirror 206 which reduces image motions in imaging system B 208. The tracking mirror 206 and the imaging system B 208 may have closed loop control dependent on individual applications, as illustrated by the dashed line. The tracking mirror 206 and the imaging system A 204 may not have closed loop control.

In one case, the imaging system A 204 does not see the motion of the tracking mirror 206, but the imaging system B 208 does. In which case, imaging system A 204 may refer to WF-SLO 120; imaging system B 208 may refer to AO-SLO 140; and the tracking mirror 206 may refer to the combination of the third scanner 149 and the fourth scanner 152 or a separate tracking mirror within the AO-SLO 140. The separate tracking mirror may be a single tip-tilt mirror or two single axis mirrors (191 and 192).

FIG. 3 is an illustration of a closed-loop control system 300 for tracking a subject 202. The subject 202 may be an eye. The closed-loop control system 300 may be done in real time. The real-time eye tracking may be from the imaging system A 204. The tracking mirror 306 and the imaging system B 208 may have closed loop control depending upon individual applications, as illustrated by the dashed lines. In this case, both imaging system A 204 and imaging system B 208 may ‘see’ the motion of the tracking mirror. In which case, imaging system A 204 may refer to WF-SLO 120; imaging system B 208 may refer to AO-SLO 140; and the tracking mirror 306 may refer to the tracking mirror 180 as illustrated in FIG. 1D. In an alternative system, the tracking mirror may refer to the combination of the first scanner 125; the second scanner 128; third scanner 149; and the fourth scanner 152.

In image based tracking systems, ‘frame out’ can be a major reason for causing unsuccessful tracking. ‘Frame out’ is when the target image moves out of the mapping range of the reference image. As a consequence, the tracking method is not able to find correct eye motions for the target images. ‘Frame out’ is uncontrollable and unpredictable due to uncontrollable eye motions. Embodiments disclosed herein can significantly reduce, if not completely eliminate, the case of ‘frame out’ as compared to the existing technologies, and at the same time, increase the bandwidth of the tracking system.

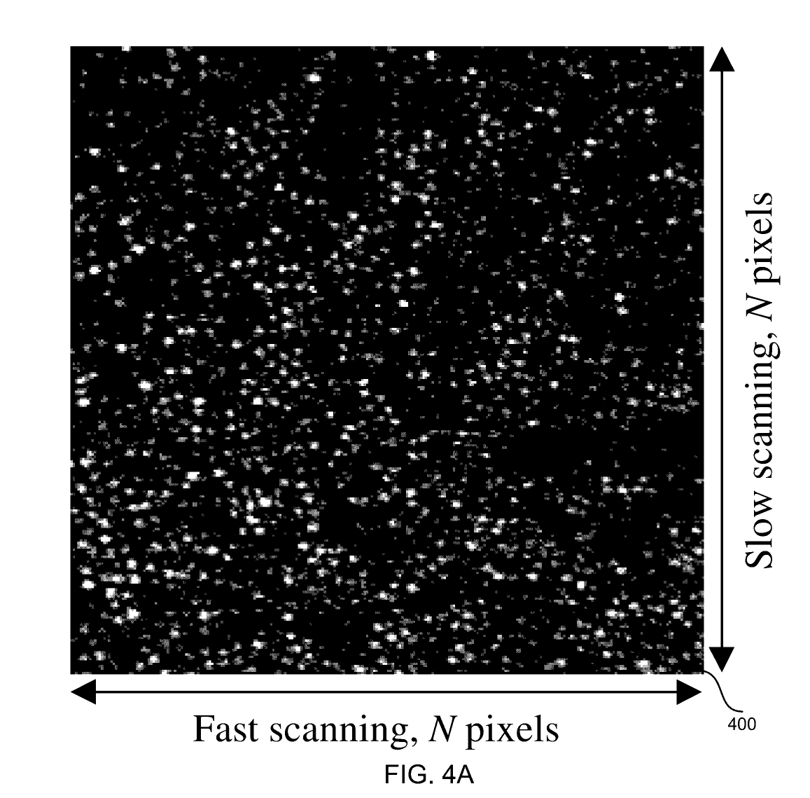

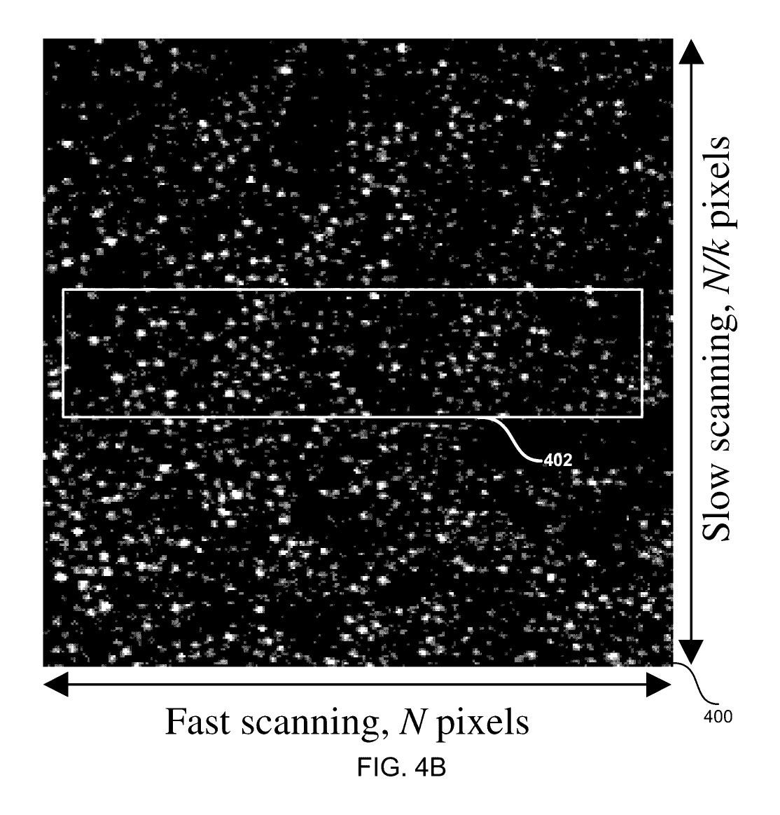

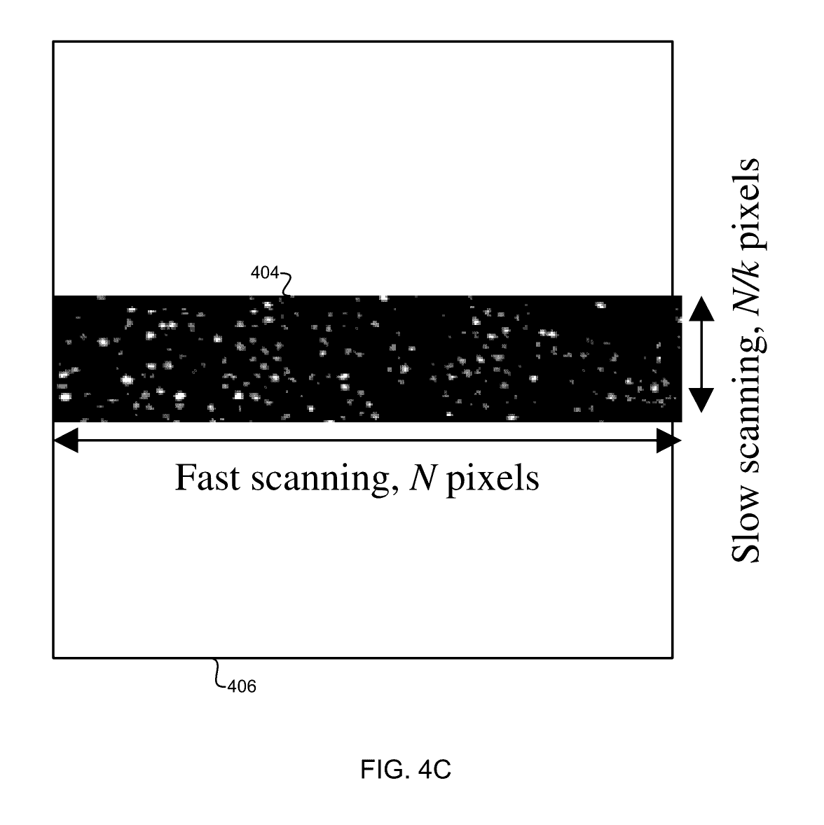

FIG. 4 is an illustration of an image 400 of a human-eye as obtained by an embodiment such as an AO-SLO 140. In which a fast scanner works in a horizontal direction and a slow scanner works in a vertical direction. The third scanner 149 may be an example of such a fast scanner. The fourth scanner 152 may be an example of slow scanner. The size of image 400 size may be N×N pixels as illustrated in FIG. 4A. Traditional image based eye tracking systems have the same image size throughout an entire video sequence. In an embodiment, subsequent images are obtained within a target frame 402 as illustrated in FIG. 4B. In which the target frame 402 is a strip in which one of the dimensions is the same as image 400 while another dimension is smaller than the corresponding dimension of image 400. FIG. 4C is an illustration of an exemplary target image 404 that is the size of a target frame 402. Also illustrated in FIG. 4C is a reference frame 406 which indicates a size and position of an image 400 that is used as a reference to detect relative movement of the subsequent images.

### Overall Method

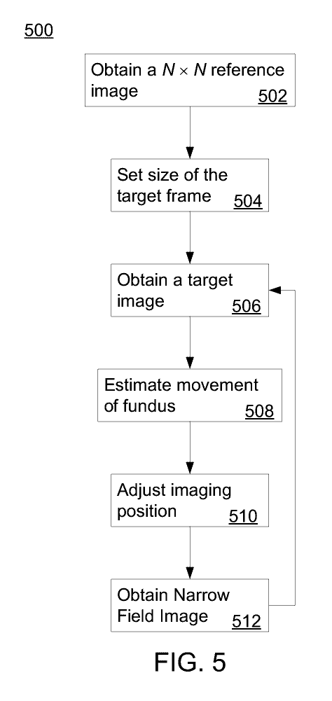

An embodiment may include a first tracking method 500 illustrated in FIG. 5. A first step 502 may include obtaining a first N×N pixel reference image such as image 400 illustrated in FIG. 4A. A second step 504 may include setting a size of a target frame 402 with a resizing factor k so that the target image has N×N/k pixels. A third step 506 may include obtaining a first target image such as the exemplary target image 404 as illustrated in FIG. 4C. A fourth step 508 may include estimating the movement of the fundus 408 based upon the target image and the reference image. A fifth step 510 may include adjusting the imaging position. A sixth step 512 may include obtaining a narrow field image. After the narrow field image is obtained the process is repeated starting with the third step 506.

In one embodiment the adjustment of the imaging position 510 may include moving the imaging position of the narrow field image. Readjusting the imaging position of the narrow field imaging area may be based on one or more characteristics of one or more of the reference image, the target image, or a previous narrow field image. The one or more characteristics may be selected from: a signal strength; a contrast ratio; and one or more features of the reference image, the target image, or the previous narrow field image. Moving the imaging position of the narrow field image may include applying an offset to the scanning signals sent to scanners 149 and 152. In another embodiment, adjusting the imaging position may include moving the imaging position of both the narrow field image and the target image. Moving the imaging position of both the narrow field image and the target image may include using the tracking mirror 180 to adjust the imaging position. Moving the imaging position of both the narrow field image and the target image may include applying an offset to the scanning signals sent to scanners 125, 128, 149, and 152. Moving the imaging position of both the narrow field image and the target image may include applying an offset to the scanning signals sent to scanners 128, 149, and 152. In which case, only the motion along one axis for the target image is not compensated for.

A digital image registration system may be used in addition to the stabilization routines described herein. Digital image registration uses this small residual motion signal to create a registered image sequence.

### Details of Embodiment

In one embodiment there may be limitations on k such that k>1 and N/k is an integer {N,k|{N,N/k}ε [symbol] ,k>1}. These limitations, improve the speed and accuracy of estimating the movement of the fundus. In one embodiment, the resizing factor k is not an integer. The value of the resizing factor k may be adjusted depending on different applications. In one embodiment, the first step 504 may be done repeatedly until the eye location is locked into place by the fixation target 160. The locking of the eye (fixation) may be determined automatically or by an operator. Once the eye is locked, the target image in step 506 may be obtained repeatedly.

One method of implementing the third step 506 is by reducing the amplitude of the driving signal by a factor of k, while maintaining the ramp rate for the slow scanner, to preserve the same pixel density between the N×N reference image and the N×N/k target image. The slow scanner may be the second scanner 128 or the fourth scanner 152. The slow scanner may be a galvano scanner driven by a triangle or ramp signal along a second axis.

The following equation (1) is a typical equation used to approximate a ramp signal with a frequency f along an y-axis. In which case: f is the scanning frequency in Hz of the slow scanner when it is obtaining the full size image which is used as a registration image (for example 60 Hz); t is the time in seconds; N is the number of pixels along the y-axis for a full size image which is used as a registration image; y is the position of the scanning spot along the y axis in terms of pixels as a function of time t, φ is a first offset which may be zero for a 0 to N−1 ramp or 1/N for a 1 to N ramp; └ ┘ is the floor function. Other equations such as one based on the modulus, or a rule based system may also be used as the driving function.

y(t)=N(ft+φ−└ft+φ┘) (1)

The following equation (2) describes how a driving function of the slow scanner may be modified to scan only a strip of pixels. In which case: k is the resizing factor discussed above; yₛₜᵣᵢₚ is the position in terms of pixels as a function of time t for driving the slow scanner over just the strip of the pixels; D is a second offset which represents a bottom position of the strip of pixels relative to the full size window.

$${y}_{strip} ( t ) = \frac{N}{k} ( fkt + φ - ⌊ fkt + φ ⌋ ) + Φ \qquad ( 2 )$$

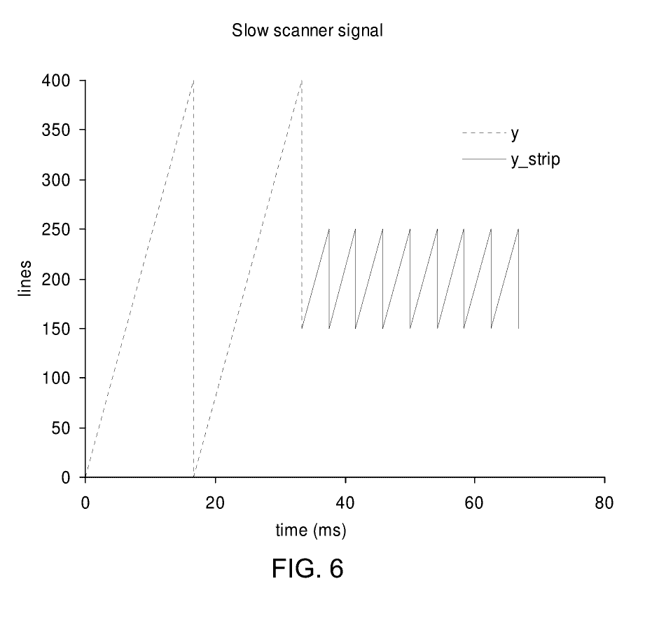

A comparison of equation (2) relative equation (1) describes how the resizing factor k is used to both reduce the amplitude and increase the frequency such that the ramp rate is held constant as illustrated in FIG. 6. FIG. 6 illustrates how the signal used to drive the slow scanner initially scans 400 lines 2 times (y) and then scans 100 lines 8 times (y_strip). The ramp rate or slope of the slow scanner driving signal is equivalent to the number of lines per unit time.

When the scanner switches from scanning a larger image to a smaller strip the operation of the resonance scanner may be held constant. When the scanner switches from scanning a larger image to a smaller strip the operation of the digitization rate is also held constant.

In one embodiment, the signal sent to the slow scanner is a voltage signal that is proportional to the movement of the scanner. In another embodiment, information that represents, the amplitude and frequency of the ramp signal is sent to a controller of the slow scanner.

Equations 1 and 2 are just approximations of the behavior of the slow scanner. In reality, there is a delay between the end of frame and a beginning of the next frame which is not taken into account in equations 1 and 2. The frame rate of the target strip images are increased by approximately a factor of k, which is dependent upon the specific hardware implementations.

With a smaller image size, the tracking system is more tolerant of eye motion in the direction of slow scanning which is more vulnerable to frame out in the direction of fast scanning. For example, when the target images are scanned from the central part of the reference image, the algorithm is able to tolerate ±(1−1/k)×N/2 pixels of eye motion in the direction of slow scanning. With the same sizes of the reference image and the target image, the tracking algorithm has zero tolerance where motion of the tracking mirror will be temporarily frozen when the part of the target image moves out of the range of the reference frame.

The increased frame rate allows the tracking system to capture frequencies of eye motions k times of those from the slow frame rate. With fast frame rate, images from the imaging system carry higher frequency information which is detected by the tracking algorithm and applied to the tracking mirror.

Due to blinking and saccades by an eye, a tracking algorithm may have to re-lock the eye location after saccades and/or blinks. In some cases, to re-lock eye location, it is better to recapture the reference image with an image size of N×N pixels so that the tracking algorithm gets sufficient information from the target image to do robust position detection.

Once the eye location has been re-locked after saccades and/or blinks, image size is switched back to N×N/k pixels by adjusting amplitude and frequency of the slow scanner to achieve robust and smooth tracking.

This eye tracking control system can be employed in both small field of view (FOV) system such as the AO-SLO 140 or a wide FOV system such as WF-SLO 120. The eye tracking system can also be employed in a system that includes a combination of a small FOV system and a wide FOV system such as in system 100.

### Imaging Areas

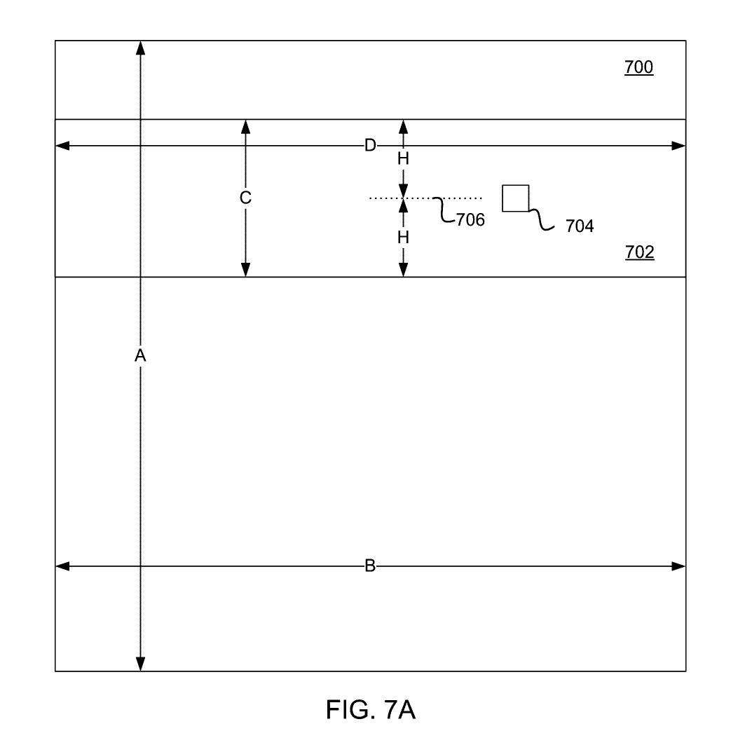

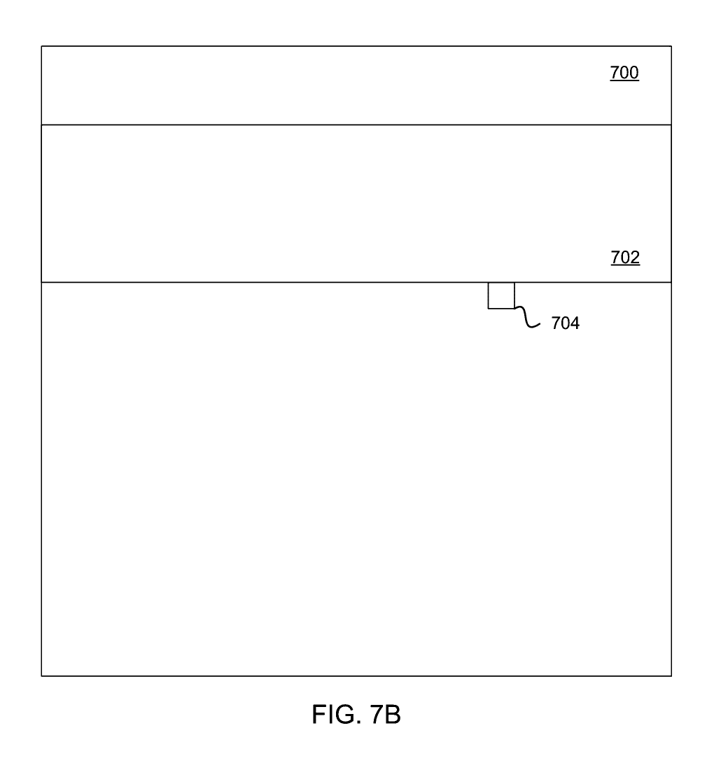

When an integrated eye-tracking system is used with both a wide FOV system and a small FOV system as in system 100, the image motion from the wide FOV system may be used to reduce the apparent image motion in the small FOV system. In which case, an offset may be applied to the wide FOV system to best match eye motions, as illustrated in FIG. 7A.

FIG. 7A is an illustration of a first imaging area 700 which is an area of the subject E that might be imaged with a wide FOV system such as the WF-SLO 120. The dimensions of the first imaging area are a first length A by a second length B. The first length A may be equal to second length B in which case the first imaging area is square. The first imaging area is also the area that may be imaged to obtain a first reference image such as reference image 400.

FIG. 7A also illustrates a second imaging area 702. The second imaging area 702 is an area of the subject E which may be obtained with a wide FOV system such as the WF-SLO 120. The dimensions of the first imaging area are a third length C by a fourth length D. The fourth length D may be substantially equal to the second length B. In the context of the present application substantially means within the alignment tolerance of the system such that deviations that have an impact on the imaging of the subject E are within noise tolerances of the measurement system 100. The third length C is less than a first length A. The orientation of the first imaging area 700 relative to the second imaging area 702 is such that: the first length A is along a first axis that is substantially parallel to a third length C; the second length B is along a second axis that is substantially parallel to a fourth length D; and the first axis is substantially parallel to the second axis.

FIG. 7A also illustrates a third imaging area 704. The third imaging area 704 is an area of the subject E which may be obtained with a small FOV system such as the AO-SLO 140. The third imaging area 704 is smaller than the second imaging area 702. The tracking system may attempt to keep the third imaging area close to a first centerline 706 of the second imaging area 702. The first centerline 706 is equidistant from the edges of the imaging area 702. The distance from the edges, which are substantially parallel to the second axis, of the imaging area 702 to the first centerline 706 is a fifth length H.

The motion of the subject E may be estimated by comparing the reference image obtained in the first imaging area at a first point in time to a target image in the second imaging area obtained at a second point in time. This estimated motion detected with the wide-FOV system reflects the eye motion seen by the small FOV system. Ideally, the third imaging area 704 is centered on the centerline 706. Such that the third imaging area 704 is located at a center of the second imaging area 702 relative to the slow scanning direction regardless of its position relative to the fast scanning direction. This may help the tracking system achieve high performance.

In an alternative embodiment, as illustrated in FIG. 7B the third imaging area 704 is moved to outside of the second imaging area 702 while still being near the second imaging area 702. This may be done by applying an offset to the second imaging area 702 relative to the position of the third imaging area 704. By avoiding an overlap of these two imaging areas it is possible to reduce the radiant exposure that is received by any one portion of the subject E. Reducing the radiant exposure in this way can allow for higher light intensity to be used while still being within the light safety budget.

In one embodiment, non-visible light is used by one or both of the wide FOV system or the small FOV system. An example of non-visible light is infrared light in which the subject has little to no ability to sense. In another embodiment the wide FOV system may be planar imaging WF-SLO, while the small or narrow FOV system is one of a: AO-SLO, a polarization sensitive SLO, optical coherence tomograph (OCT), or a polarization sensitive OCT.

In one embodiment, an imaging size of the third imaging area 704 is adjusted. The imaging size of the third imaging area 704 may be adjusted based on one or more of: an amount of the estimated movement of the fundus; a signal strength of a previous narrow field image; and a contrast ratio of the previous narrow field image.

### Second Tracking Method

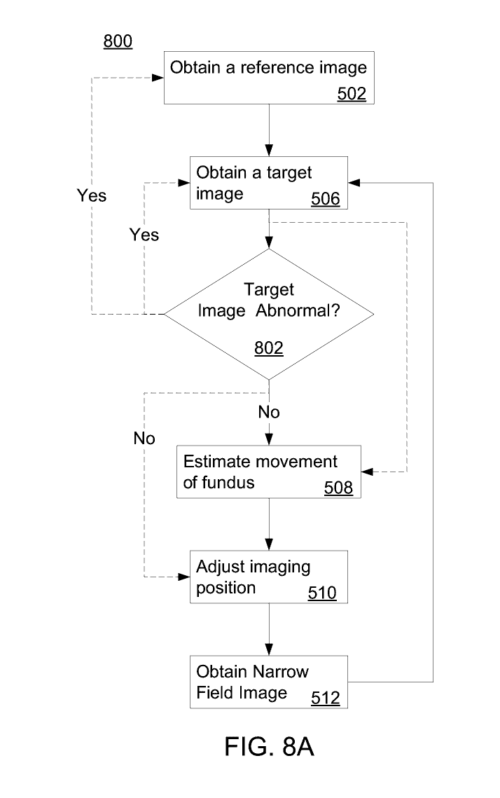

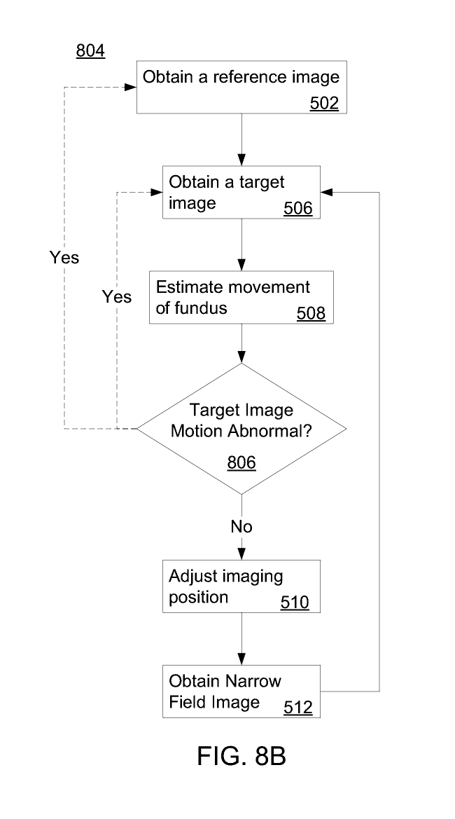

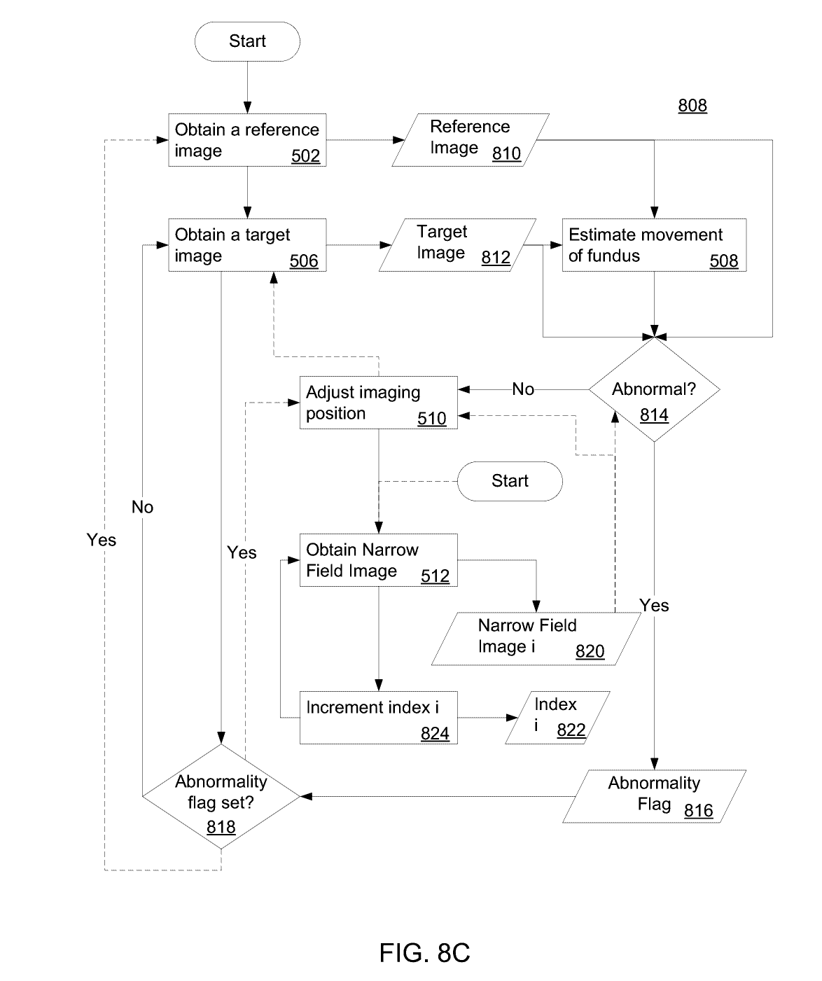

An embodiment may include a second tracking method 800 illustrated in FIG. 8A that is similar to tracking method 500. A first step 502 may include obtaining a first N×N pixel reference image such as image 400 illustrated in FIG. 4A in the first imaging area 700. The first imaging area 700 may be also referred to as the reference imaging area 700. The first imaging area 700 is an area of a subject E that is being imaged. In particular, the first imaging are may include the fundus Ea.

A third step 506 may include obtaining a first target image such as the exemplary target image 404 as illustrated in FIG. 4C in the second imaging area 702. The target image has N×N/k pixels.

A first alternative step 802 may include determining if the target image is abnormal. If the target image is abnormal then the method returns to the first step 502 and/or the third step 506 in which the target image and the reference image are re-obtained or the target image is re-obtained. The target image may be considered abnormal if a blink is detected in the target image or the reference image. The target image may be considered abnormal if the fundus Ea has moved so much that the accuracy of the movement estimation deteriorates. One test for determining if the fundus Ea has moved too much is to compare an overlap percentage that represents a portion of the target image that overlaps with reference image is less than an overlap threshold. Another abnormality test may include taking the overlap percentage and the region the reference image in which the overlaps occurs into consideration.

A fourth step 508 may include estimating the movement of the fundus Ea based upon the target image and the reference image. A fifth step 510 may include adjusting the imaging position. A sixth step 512 may include obtaining a narrow field image. After the narrow field image is obtained the process is repeated starting with the third step 506.

In an alternative version, the movement of the fundus is estimated in step 508 at the same time as the abnormality of the target image is tested in step 802. In which case, the imaging position is only adjusted in step 510 if the target image is not abnormal. If the target image is determined to be abnormal then the estimation of the movement of the fundus is ignored or the estimation calculation is stopped.

### Third Tracking Method

An embodiment may include a third tracking method 804 illustrated in FIG. 8B that is similar to the second tracking method 800. A first step 502 may include obtaining a first reference image. A third step 506 may include obtaining a first target image. A fourth step 508 may include estimating the movement of the fundus Ea based upon the target image and the reference image.

A second alternative step 806 may include determining if the target image motion is abnormal. If the target image motion is abnormal then the method returns to the first step 502, and/or the third step 506, and the fourth step 508 in which the target image or target image and the reference image are re-obtained and the motion is re-estimated. The target image motion may be considered abnormal if the estimated movement is greater than a movement threshold. The target image motion may be considered abnormal if a confidence value which represents a probability that the estimated movement is correct is greater than a confidence threshold. The target image motion may be considered abnormal if a number (3 for example) consecutive target images have a larger than usual motion and they are all moving in the same direction. The target image motion may be considered abnormal if a larger-than-usual motion is followed by a small motion, or is followed by another larger-than-usual motion but in the opposite direction, this larger-than-usual motion may be treated as a spurious motion and may not be used as part of a closed loop motion compensation system. Other abnormality tests may be used which indicate that the reference image should be re-obtained.

If the motion is not considered abnormal in the step 806 then the fifth step 510 may include adjusting the imaging position. A sixth step 512 may include obtaining a narrow field image. After the narrow field image is obtained, the process is repeated starting with the third step 506.

### Fourth Tracking Method

An embodiment may include a fourth tracking method 808 illustrated in FIG. 8C that is similar to the third tracking method 804. The fourth tracking method 808 illustrates a system in which the tracking system and the imaging systems are described as parallel independent systems. The previous tracking methods may also be implemented as parallel systems. A first step 502 may include obtaining a reference image 810. A third step 506 may include obtaining a target image 812 repeatedly. A fourth step 508 may include estimating the movement of the fundus Ea based upon the target image 812 and the reference image 810.

In parallel with the tracking system, a Narrow Field image i 820 is obtained in the sixth step 512. The fourth tracking method 808 may start by starting with the first step 502 and the sixth step 512 at the same time or at times that are close together. After the Narrow Field image i 820 is obtained in the sixth step 512 the index i 822 is incremented in an incrementing step 824. After the incrementing step 824 the next Narrow Field image i 820 is obtained in the sixth step 512, thus forming a loop for repeatedly obtaining a series of narrow field images. The series of narrow field images may overlap so that a video series may be obtained. Alternatively, the series of narrow field images do not substantially overlap so that a larger detailed image may be stitched together.

A third alternative step 814 may include determining if there is something abnormal in the imaging data. The third alternative step 814 may make the abnormality determination based on the target image 812, the reference image 814, and the estimation motion of the fundus Ea. The third alternative step 814 may include one or both of the first alternative step 802 and the second alternative step 806.

If in the alternative step 814 no abnormality is found in the image data then the estimated movement of the fundus Ea is used to adjust the imaging position in the fifth step 510. In one embodiment, adjusting the imaging position includes moving the imaging position of the narrow field imaging area which may include applying an offset to the scanning signals sent to scanners 149 and 152. In another embodiment, adjusting the imaging position may include moving the imaging position of both the narrow field imaging area and the target imaging area which may include using the tracking mirror 180 to adjust the imaging position. Moving the imaging position of both the narrow field imaging area and the target imaging area may include applying an offset to the scanning signals sent to scanners 125, 128, 149, and 152 or tracking mirror 180. Moving the imaging position of both the narrow field imaging area and the target imaging area may include applying an offset to the scanning signals sent to scanners 128, 149, and 152 or tracking mirror 180. In which case, only the motion along one axis for the target imaging area is compensated for, and the motion along the orthogonal axis is not compensated for.

Adjusting the imaging position 510 may be done in intra-frame, inter-frame, or inter-line manners. When adjusting the imaging position in the step 510 is done in an inter-frame manner then the imaging position is only done in between obtaining individual frames in between instances of steps 506 and 512. When adjusting the imaging position in step 510 is done in an intra-frame manner then the imaging position is adjusted while a frame is being obtained during steps 506 and 512. When adjusting the imaging position in step 510 is done in an inter-line manner then the imaging position is adjusted only between lines of data during steps 506 and 512.

If the imaging is determined to be abnormal in a step 814 than an abnormality flag 816 may be set. In one embodiment, the abnormality flag 816 may be checked in a step 818 after the target image 812 is obtained and before it is obtained again in a step 506. If it is determined in step 818 that yes the abnormality flag 816 has been set then the reference image 810 is re-obtained in step 502, the target image 812 is re-obtained in step 506, and the abnormality flag is reset. If it is determined in step 818 that the abnormality flag 816 has not been set then the target image 812 is re-obtained in step 506. In another embodiment, the abnormality flag is checked in step 818 while the target image 812 is being obtained instead of after, in which case the system stops obtaining the target image 812, resets the abnormality flag 816, re-obtains the reference image 810 in step 502, and then re-obtains the target image 506. In an alternative embodiment steps 814 and 818 are not performed, the abnormality of the system is not checked but the imaging positions of the imaging areas are positioned independently of the image scanning. In an alternative embodiment, the abnormality flag is checked before the imaging position of either the target image position or the narrow field image position is adjusted.

In an alternative embodiment, one or more of the Narrow Field images i 820 may be analyzed to determine if any abnormalities are detected in a step 814 and/or one or more of the Narrow Field images i 820 may be analyzed to make an additional estimation of the movement of the fundus similar to the manner of step 508 which is then used in step 510.

In an alternative embodiment, if the imaging is determined to be abnormal but that the abnormality is less than threshold the image position is adjusted in the step 510 and the abnormality flag 816 is also set.

In an alternative embodiment, multiple target images 812 are used to estimate the movement of the fundus in step 508 and/or check for abnormalities in step 814.

In an alternative embodiment, the step 510 may include adjusting the imaging position with two separate feedback loops which act independently from each other. A first feedback loop may be based upon the movement estimated in step 508. The second feedback loop may be based upon a comparison of the current Narrow Field Image i 820 a previous Narrow Field Image or another reference image obtained with an imaging system that is different from the imaging system used to obtain the Narrow Field Image. The first feedback loop may send a first beam steering signal to a first beam steering system. The second feedback loop may send a second beam steering signal to a second beam steering system. The first beam steering system and the second beam steering system may include components that overlap with the scanning system that is used to obtain the narrow field images. The first beam steering system and the second beam steering system may include tip tilt mirrors or scanning mirrors.

### Controller

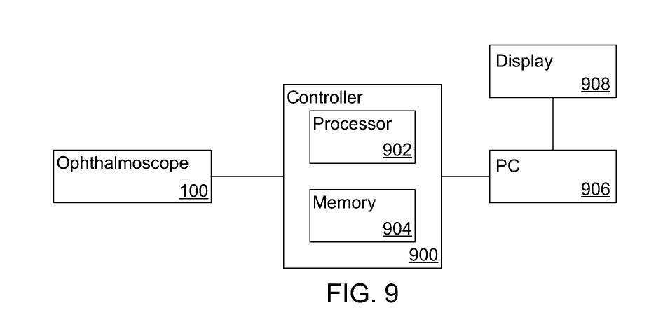

FIG. 9 is an illustration of the controller 900 that may be used in an embodiment. The controller 900 receives input signals and outputs control signals. The controller 900 may be a general purpose computer, a device specifically designed to control the ophthalmoscope 100, or a hybrid device that uses some custom electronics along with a general purpose computer. The input signals and control signals maybe digital signals or analog signals. The controller 900 may include an analog to digital converter (ADC) and a digital to analog converter (DAC). The input signals may include one more signals such as a signal from the wavefront sensor 146, a signal from the detector 131, the detector 155, and one or more signals from one or more other sensors. The control signals may include a first control signal to a wavefront correction device 148 and signals to one or more of the scanners 125, 128, 149, and 152 and/or mirror 180. The control signals may include additional signals to other components of the ophthalmoscope 100.

The controller 900 includes a processor 902. The processor 902 may be a microprocessor, a CPU, an ASIC, a DSP, and/or a FPGA. The processor 902 may refer to one or more processors that act together to obtain a desired result. The controller 900 may include a memory 904. The memory 904 may store calibration information and/or actual images used for tracking. The memory 904 may also store software for controlling the ophthalmoscope 100. The memory 904 may be a form of a non-transitory computer readable storage medium. The non-transitory computer readable storage medium may include, for example, one or more of a hard disk, a random-access memory (RAM), a read only memory (ROM), a distributed storage system, an optical disk (CD, DVD or Blu-Ray Disc, a flash memory device, a memory card, or the like.

The controller 900 may be connected to a computer 906 via a direct connection, a bus, or via a network. The computer 906 may include input devices such as a keyboard, a mouse or a touch screen. The controller 900 may include one or more input devices such as a keyboard, a mouse, a touch screen, knobs, switches, and/or buttons. The computer 906 may be connected to a display 908. The results of the ophthalmoscope 100 may be presented to a user via the display 908. The image tracking and fundus movement estimation may be performed by the controller 900 independently of the computer 906 or with the help of the computer 906.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A method of obtaining an image of a fundus, the method comprising:
acquiring a reference image representing light reflected from a reference imaging area of the fundus at a first point in time;
acquiring a target image representing light reflected from a target imaging area of the fundus at a second point in time after the first point in time, wherein:
all or a portion of the target imaging area overlaps with the reference imaging area; and
estimating movement of the fundus between the first point in time and the second point in time is based upon at least the target image and the reference image; and
acquiring a narrow field image representing light reflected from a narrow field imaging area of the fundus, wherein:
an area of the narrow field imaging area is less than an area of the target imaging area; and
a position of the narrow imaging area on the fundus is adjusted based on the estimated movement of the fundus.

2. The method of claim 1, wherein a pixel density of the target image is equal to a pixel density of the reference image.

3. The method of claim 1, further comprising:
determining if the target image or the estimated movement of the target imaging area is abnormal;
in a first case that the target image or the estimated movement of the target imaging area is abnormal, reacquiring the target image before obtaining the narrow field image; and
in a second case that the target image or the detected movement of the target imaging area is not abnormal, reacquiring the target image representing light reflected from the target imaging area taking the detected movement into account.

4. The method of claim 3, wherein:
in the first case also reacquiring the reference image before obtaining the narrow field image.

5. The method of claim 3, wherein one or more conditions may be used to determine if the target image is abnormal or the estimated movement is abnormal, the conditions include:
the estimated movement is greater than a movement threshold;
a confidence value which represents a probability that the estimated movement is correct is greater than a confidence threshold;
an overlap percentage that represents a portion of the target image that overlaps with the reference image is less than an overlap threshold; and
a blink has been detected.

6. The method of claim 1, wherein:
the reference image is obtained with a first imaging system;
the target image is obtained with the first imaging system;
the narrow field image is obtained with a second imaging system; and
the first imaging system and the second imaging system share some optical components.

7. The method of claim 6, wherein:
the first imaging system is a scanning laser ophthalmoscope; and
the second imaging system is an adaptive optics scanning laser ophthalmoscope.

8. The method of claim 1, wherein:
the reference image and the target image are obtained with a scanning laser ophthalmoscope that includes a first scanner;
a first signal is used to drive the first scanner, such that the reference image is obtained;
a second signal is used to drive the first scanner, such that the target image is obtained;
a first ramp rate of the first signal is substantially equal to a second ramp rate of the second signal.

9. The method of claim 8, wherein
the scanning laser ophthalmoscope further comprises a second scanner;
the second scanner scans in the first direction at a second scanning rate forming lines of the reference image and the target image; and
the first scanner scans in the second direction at a first scanning rate faster than the second scanning rate forming the reference image and the target image.

10. The method of claim 1, wherein a reference image pixel density of the reference image is substantially equal to a target image pixel density of the target image.

11. The method of claim 1, wherein a reference image line density of the reference image is substantially equal to a target image line density of the target image.

12. The method of claim 1, wherein the movement of the fundus is estimated by using one or more of the techniques selected from the group consisting of:
one or more cross-correlation techniques;
one or more Fourier transform techniques;
one or more sequential similarity detection techniques;
one or more phase correlation techniques; and
one or more landmark mapping techniques.

13. A non-transitory computer readable medium encoded with instructions for performing the method of claim 1.

14. The method of claim 1, further comprising:
readjusting a position of the target imaging area at a first rate, based on the previous estimated movement;
reacquiring the target image at the adjusted position at the first rate;
re-estimating the movement of the fundus based upon at least a most recently obtained target image and the reference image;
reacquiring the narrow field image, at a position that has been re-adjusted based on the most recent estimation of the movement of the fundus; and
wherein, a period of time between the reacquiring of subsequent target images at the first rate is less than a period of time that is used to obtain the reference image.

15. The method of claim 14, wherein:
adjusting and readjusting the target imaging area is done by adding one or more target image offsets to one or more target image signals which are sent to one or more target image scanning mirrors that are used to scan the target imaging area, wherein the one or more target image offsets are based on the most recently obtained estimated motion of the fundus; and
adjusting and readjusting the narrow field imaging area is done by adding one or more narrow field offsets to one or more narrow field signals which are sent to one or more narrow field scanning mirrors that are used to scan the narrow field imaging area, wherein the one or more narrow field offsets are based on the most recently obtained estimated motion of the fundus.

16. The method of claim 14, wherein:
the target imaging offsets are such that a position of the target imaging area is adjusted along a first axis and is not adjusted along a second axis orthogonal to the first axis.

17. The method of claim 14, wherein:
adjusting and readjusting the target imaging area and the narrow field imaging area is done by adding one or more offsets to one or more signals which are sent to one or more mirrors that are used to position both the target imaging area and the narrow field imaging area, wherein the one or more offsets are based on the most recently obtained estimated motion of the fundus.

18. The method of claim 14, wherein the narrow field image and the target image are both reacquired concurrently.

19. The method of claim 1, wherein the estimation of the movement of the fundus is also based upon one or more narrow field images.

20. The method of claim 1, wherein the position of the narrow imaging area on the fundus is adjusted and readjusted such that narrow field image does not overlap with the target image.

21. The method of claim 1, wherein the light reflected from the reference imaging area of the fundus, the light reflected from the target imaging area of the fundus, and the light reflected from the narrow field imaging area of the fundus are one of non-visible light or infrared light.

22. The method of claim 1, wherein:
the light reflected from the reference imaging area of the fundus, and the light reflected from the target imaging area of the fundus, have a first wavelength spectrum;
the light reflected from the narrow field imaging area has a second wavelength spectrum different from the first wavelength spectrum.

23. The method of claim 1, further comprising:
readjusting an imaging position of the target imaging area based on one or more characteristics of one or more of the reference image, the target image, or a previous narrow field image; and
wherein the one or more characteristics are selected from: a signal strength; a contrast ratio; and one or more features of the reference image, the target image, or the previous narrow field image.

24. The method of claim 1, further comprising:
adjusting an imaging size of the target imaging area based on one or more of:
an amount of the estimated movement of the fundus;
a signal strength of the reference image and the target image; and
a contrast ratio of the reference image and the target image.

25. An apparatus for obtaining an image of a fundus, comprising:
one or more processors;
a first imaging system for obtaining an image of the fundus; and
a second imaging system for obtaining an image of the fundus;
wherein in the first imaging system and the second imaging system share one or more optical components;
acquiring a reference image representing light reflected from a reference imaging area of the fundus with the first imaging system at a first point in time;
acquiring a target image representing light reflected from a target imaging area of the fundus first imaging system at a second point in time after the first point in time, wherein:
all or a portion of the target imaging area overlaps with the reference imaging area; and
wherein the one or more processors estimates movement of the fundus between the first point in time and the second point based upon at least the target image and the reference image; and
acquiring a narrow field image at representing light reflected from a narrow field imaging area of the fundus with the second imaging system, wherein:
an area of the narrow field imaging area is less than an area of the target imaging area; and
a position of the narrow field image on the fundus is adjusted based on the estimated movement.

26. The apparatus of claim 25, further comprising:
one or more light sources for providing non-visible light or infrared light to the fundus which is used by the first imaging system and the second imaging system to irradiate the fundus for obtaining images of the fundus.
